(19) United States
(12) Patent Application Publication
(10) Pub. No.: US 2016/0092361 A1
(43) Pub. Date: Mar. 31, 2016

(54) CACHING TECHNOLOGIES EMPLOYING DATA COMPRESSION

(71) Applicant: Intel Corporation, Santa Clara, CA (US)

(72) Inventors: KNUT S. GRIMSRUD, Forest Grove, OR (US); SANJEEV N. TRIKA, Portland, OR (US)

(21) Appl. No.: 14/497,392

(22) Filed: Sep. 26, 2014

(51) Int. Cl. G06F 12/08; G06F 12/02

(52) U.S. Cl. CPC G06F 12/0833; G06F 12/0238; G06F 2212/621; G06F 2212/202

(57) ABSTRACT

Caching technologies that employ data compression are described. The technologies of the present disclosure include cache systems, methods, and computer readable media in which data in a cache line is compressed prior to being written to cache memory. In some embodiments the technologies enable a caching controller to understand the degree to which data in a cache line is compressed, prior to writing the compressed data to cache memory. Consequently the cache controller may determine where the compressed data is to be stored in cache memory based at least in part on the size of the compressed data, a compression ratio attributable to the compressed data (or its corresponding input data), or a combination thereof.

### TECHNICAL FIELD

The present disclosure relates to caching technologies. In particular the present disclosure relates to drive caching technologies that employ data compression.

### BACKGROUND

Electronic devices such as desktop computers, laptop computers, smart phones, tablets, and the like often include one or more peripheral storage devices. For example, a desktop computer may include a hard disk drive (HDD) that includes a magnetic recording medium (disk) that is configured to persistently store data. Although useful, the input/output (e.g., write/read) performance of an HDD may be relatively slow compared to other components of the device. HDDs and other relatively slow storage devices (e.g., tape memory) may therefore bottleneck the performance of the electronic device in which it/they is/are installed. Although many attempts have been made to improve their performance, the electro-mechanical nature of HDDs may practically limit the degree to which their performance may be improved.

One way to relieve a bottleneck presented by a relatively slow peripheral storage device is to use a cache device (also referred to herein as a “cache”). In general, a cache device is a memory device that logically resides between a relatively slow storage device and other components of an electronic device, such as a processor. Typically a cache includes memory that is relatively fast compared to the relatively slow storage device with which the cache device is associated. The memory of the cache device may serve as a temporary storage area for the peripheral storage device. For example frequently accessed (“hot”) data may be placed in the cache after it is initially accessed, e.g., from the relatively slow storage device. Subsequent accesses to the hot data may thereafter be made to the cache instead of the relatively slow storage device. A cache controller may apply one or more algorithms and/or policies to determine which data is stored in the memory of the cache device, and which is removed. Because the cache is faster than the relatively slow storage device, the input/output performance of the system may be improved.

Although cache devices can alleviate the performance bottleneck introduced by relatively slow peripheral storage devices, cache memory is often quite expensive. The size of a cache may therefore be limited by cost and/or other considerations. Consequently, the amount of data that may be stored in a cache may be practically limited by the size of its memory.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a block diagram of a caching system consistent with the present disclosure;

FIG. 2 depicts example commands that may be employed by a caching system consistent with the present disclosure;

FIG. 3 is a flow chart of example operations of a cache controller module in an example method of caching data consistent with the present disclosure; and

FIG. 4 is a flow chart of example operations of a data compression module in an example method of caching data consistent with the present disclosure.

FIGS. 5A and 5B are block diagrams of an example electronic device including a caching system consistent with the present disclosure.

### DETAILED DESCRIPTION

While the present disclosure is described herein with reference to illustrative embodiments for particular applications, it should be understood that such embodiments are exemplary only and that the invention as defined by the appended claims is not limited thereto. Indeed for the sake of illustration the technologies described herein may be discussed in the context of one or more use models in which a solid state drive is used as cache device for a storage device, such as a hard disk drive or tape memory. Such discussions are exemplary only, and it should be understood that all or a portion of the technologies described herein may be used in other contexts. Indeed the technologies described herein may be used with any suitable cache device and storage device. Those skilled in the relevant art(s) with access to the teachings provided herein will recognize additional modifications, applications, and embodiments within the scope of this disclosure, and additional fields in which embodiments of the present disclosure would be of utility.

The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. Such devices may be portable or stationary. In some embodiments the technologies described herein may be employed in a desktop computer, laptop computer, smart phone, tablet computer, netbook computer, notebook computer, personal digital assistant, server, combinations thereof, and the like. More generally, the technologies described herein may be employed in any electronic device to which one or both of a cache device and storage device may be coupled and/or installed.

The term “cache device” is used herein to refer to a memory device that is used as a cache for another memory device (hereinafter referred to as a “storage device”). Although the present disclosure focuses on embodiments in which a solid state drive is used as a cache device, it should be understood that such descriptions are exemplary only and that the term “cache device” encompasses any type of memory device that may be used as a cache for a storage device. Without limitation, in some embodiments the cache devices described herein are in the form of a solid state drive, dynamic random access memory (DRAM), a hard drive, combinations thereof, and the like. In some embodiments the caching devices described herein exhibit input/output (“I/O”) performance that is greater than that of an associated storage device. Therefore in some embodiments, the cache devices described herein may include a memory (also referred to herein as “cache memory”) that is faster than the memory of a storage device with which the cache device is associated.

The term “storage device” is used herein to refer to a memory device that may be used to persistently store data. Non-limiting examples of cache devices include hard drives (e.g., drives employing magnetic recording media), solid state drives, tape memory, combinations thereof, and the like. In some embodiments, the storage devices described herein are in the form of one or more memory devices that exhibit I/O performance that is lower than the I/O performance of an associated cache device. Therefore in some embodiments, the storage devices described herein may include a memory (also referred to herein as “storage memory) that is slower than the memory of a cache device with which the storage device is associated.

As used in any embodiment herein, the term “module” may refer to software, firmware, circuitry, and/or combinations thereof that is/are configured to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may, collectively or individually, be embodied as circuitry that forms a part of one or more electronic devices, as defined previously. In some embodiments one or more modules described herein may be in the form of logic that is implemented at least in part in hardware to perform one or more functions consistent with the present disclosure.

The terms “solid state drive,” “SSD,” “SSDs” are interchangeably used herein to refer to any of the wide variety of data storage devices in which integrated circuit assemblies (e.g., non-volatile random access memory (NVRAM) assemblies) are used to store data persistently. In any case, an SSD may be understood to include non-volatile memory such as negated and not and (NAND) and/or not or (NOR) memory.

The terms “hard drive” and “HDD” are interchangeably used herein to refer to data storage devices that include magnetic recording media to persistently store data. The term “hybrid hard drive,” “hybrid hard drive” and “hybrid HDD” refer to data storage devices that include a combination of integrated circuit assemblies such as NVRAM and magnetic recording media. Hybrid HDDs include so called “dual-drive hybrid systems” (in which a separate SSD and HDD are combined into a hybrid volume, e.g., by an operating system or other controlling hardware/software) and “solid state hybrid drives” in which non-volatile memory such as NAND memory is incorporated into a hard drive.

As noted in the background, cache devices can alleviate at least some of the performance bottleneck that may be introduced by relatively slow peripheral storage devices. However cost and/or other considerations may practically limit the size of the memory that may be included in a cache device. As the amount of data that may be stored in a cache device is limited by the size of the cache memory, this may impose a meaningful constraint on the performance improvements that may be attained through the use of a cache device.

With the foregoing in mind, compressing data that is to be stored in the memory of a cache device may offer significant benefits to cache systems. For example data compression can enable more data to be stored in a cache device without the need to increase the amount of memory therein. However various considerations have made it practically difficult to implement data compression in many cache devices.

For example many cache controllers are configured to divide up received data/state into cache lines that are of a fixed size (e.g., 4 kilobytes (KB), 6 KB, 8 KB, etc.). Thus for example, a cache controller may determine that a 64 KB state should be written to cache memory. To accomplish this, the controller may divide the 64 KB state into sixteen, 4 KB cache lines. The controller may then send a write command to a cache device, resulting in the writing of each 4 KB cache line to storage blocks in the cache memory. As the state contained in the 4 KB cache line is not compressed, the controller will typically allocate a 4 KB block of cache memory for storage.

As noted above the capacity of cache memory in a cache device may be practically increased by compressing the data in each cache line. However the data in each cache line may compress differently, e.g., due to differences in the data patterns contained therein. For example, a data pattern in a first cache line may compress two times (meaning the compressed data is one half the size of the input data), a data pattern in a second cache line may compress eight times (meaning the compressed data is one eighth the size of the input data), whereas a data pattern in a third cache line may not compress at all (meaning the compressed data and input data are the same size). With this in mind, in prior cache systems employing compression the cache controller is not aware of the size of the compressed data in a cache line before the compressed data is written to cache memory. The controllers in such systems therefore generally allocate the full cache line size in the cache memory, even if the size of the compressed data in a given cache line is less than the full cache line size. For example, data in a 4 KB cache line may be compressed to 2 KB, but the cache controller may be unaware of the size of the compressed data. The controller may therefore allocate a 4 KB block in the cache memory for storage of the data in that cache line, even though the size of the compressed data is only 2 KB.

Prior cache systems employing compression are therefore generally unable to directly utilize the additional space that is freed up by the compression. Rather to utilize the advantages made available by compression, such systems must query the cache device after the compressed data is written to determine whether the size of the cache memory has changed and/or to determine the amount of cache memory that is available.

With the foregoing in mind the present disclosure relates to caching technologies that employ data compression. As will be described in detail below, the technologies of the present disclosure include cache systems and methods in which data in a cache line is compressed prior to being written to cache memory. Unlike prior cache systems employing compression, the technologies of the present disclosure enable a caching controller to understand the degree to which data in a cache line is compressed, prior to writing the compressed data to cache memory. In some embodiments, the cache controllers described herein may determine where the compressed data is to be stored in cache memory based at least in part on the size of the compressed data, a compression ratio attributable to the compressed data (or its corresponding input data), or a combination thereof.

One aspect of the present disclosure therefore relates to systems for caching data, which are also referred to herein as caching systems. It is noted that for the sake of clarity and ease of understanding the caching systems described herein are described independently of a host device and/or system in which the cache system may be used and/or installed. It should be understood that the cache systems may be used with and/or installed in any suitable host device or system, which may be in the form an electronic device as defined above and/or a component thereof, such as a solid state drive or other memory device used as cache for one or more peripheral storage devices. Without limitation, the cache systems described herein are particularly suitable for caching one or more storage devices that may be employed in a desktop computer, laptop computer, mobile phone, smart phone, tablet persona computer, server, data center, combinations thereof, and the like. More generally, the cache systems described herein may be implemented in any device that may benefit from caching a relatively slow peripheral storage device.

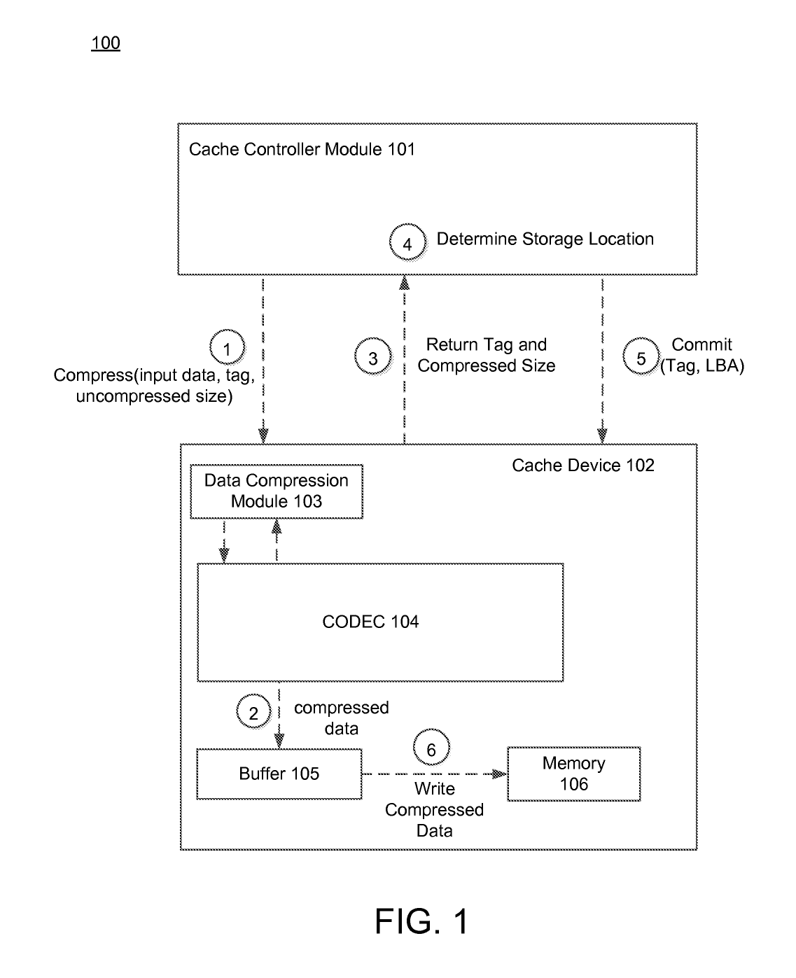

In this regard reference is made to FIG. 1, which is a block diagram of an example cache system consistent with the present disclosure. As shown, cache system 100 includes cache controller module (CCM) 101 and cache device 102.

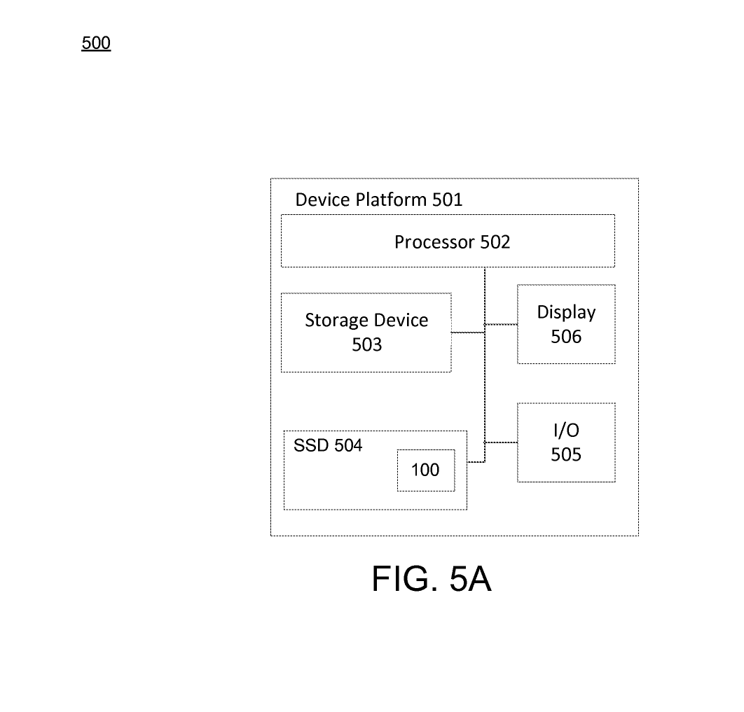

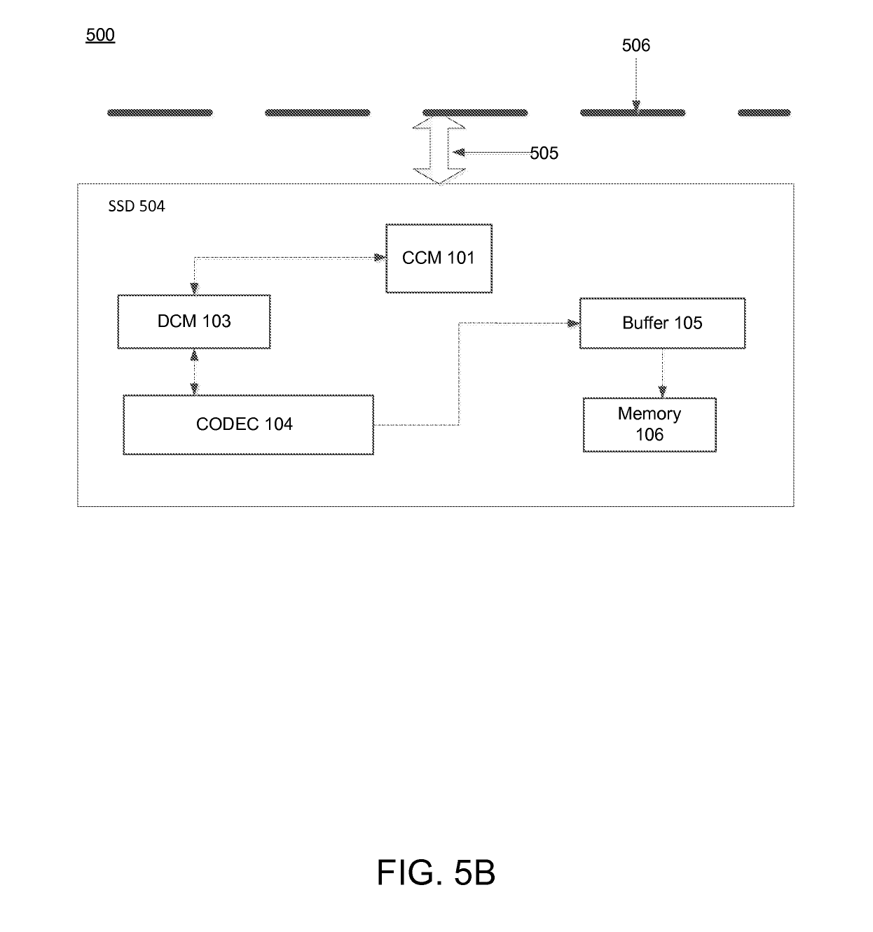

It is noted that CCM 101 is illustrated in FIG. 1 as being separate from cache device 102. It should be understood that such illustration is for the sake of example only, and that CCM 101 may be present at any suitable location. For example and as indicated in FIG. 1, in some embodiments CCM 101 is in the form of a module that is separate from cache device 102. In such embodiments CCM 101 may be installed or otherwise present in an electronic device (e.g., host system, not shown) with which cache system 100 is used. In such instances CCM 101 may be in wired or wireless communication with cache device 102. Alternatively, CCM 101 may be integral with cache device 102, e.g., as shown in FIGS. 5A and 5B. For example, CCM 101 may be in the form of or include an on-board cache controller of cache device 101. In some embodiments, cache system 100 is included in a solid state disk, and CCM 101 is in the form of or includes a SSD controller.

In any case, CCM 101 may be in the form of software, firmware, hardware, logic implemented at least in part in hardware, or a combination thereof which is configured to control the storage of data/state in cache device 102 or, more particularly, in memory 106 of cache device 102. CCM 101 may therefore implement one or more known or future caching policies and/or algorithms to determine which data/state should be stored and/or removed from cache device 102. Alternatively or in addition to such functions CCM 101 may also be configured to determine where data/state is to be stored in memory 106 of cache device 102. As will be described in detail later, CCM 101 may allocate blocks (e.g., logical block addresses or LBAs) within memory 106 based at least in part on the size of compressed data/state, a compression ratio attributable to the compressed data/state, or a combination thereof.

Cache device 102 may be any data storage device that is suitable for caching a relatively slow peripheral storage medium (not shown). Non-limiting examples of suitable data storage devices that may be used as cache device 102 include solid state drives, hard drive drives, dynamic random access memory (DRAM) devices, combinations thereof, and the like. Consistent with the foregoing description, cache device 102 may in some embodiments be any data storage device that exhibits input/output (write/read) performance that is greater than that of the peripheral storage medium for which the data storage device is to be used as cache. Without limitation, in some embodiments cache device 102 is in the form of a solid state drive.

As shown in FIG. 1, cache device 102 includes data compression module (DCM) 103, compression decompression engine (CODEC) 104, transfer buffer (buffer) 105, and memory 106. DCM 103 generally functions to communicate with CCM 101 and to cause cache device 102 to perform data compression operations consistent with the present disclosure. Further detail regarding the operation of DCM 103 will be provided later.

CODEC 104 generally functions to compress data received from CCM 101. In particular and as will be described below, CODEC 104 may receive data in a cache line from CCM 101 (or, more particularly, from DCM 103). For the sake of clarity the data received by CODEC 104 is referred to as input data. While the present disclosure describes embodiments in which the CODEC operates on input data from a single cache line, it should be understood that such description is for the sake of example and that CODEC may be configured to operate on input data from multiple cache lines. Thus for example, CCM 101 may divide a pool of data into a plurality of cache lines, each of which contains input data (e.g., 4 KB, 8 KB, etc.). CCM 101 (or DCM 103) may send the input data from one or more of the cache lines to CODEC 104 for compression. Depending on its configuration, CODEC 104 may operate one only one of the sets of input data (i.e., input data from one cache line) at a time, or it may operate on multiple sets of input data (i.e., input data from multiple cache lines) simultaneously.

CODEC 104 may then perform compression operations on the input data, e.g., using one or more compression algorithms, so as to produce a compressed output. As may be appreciated, the size of the compressed output may differ from the size of the input data. The relative difference between the size of the compressed output and the input data may be represented by a compression ratio, which in some embodiments may be determined by dividing the size of the input data by the size of the compressed output, or vice versa. Thus for example if the size of the input data is 4 KB and the size of the compressed output is 2 KB, the compression ratio may be 0.5 or 2, depending on how the ratio is calculated.

Non-limiting examples of compression algorithms that may be executed by CODEC 104 include the Lempel-Ziv (LZ) algorithm, the Deflate algorithm, the LZR algorithm and combinations thereof. Of course, these algorithms are exemplary only, and any suitable compression algorithm (and in particular lossless compression algorithms) may be used. Without limitation, in some embodiments CODEC 104 executes the Lempel-Ziv algorithm on data/state received from CCM 101 (or, more particularly, from DCM 103).

FIG. 1 illustrates an embodiment wherein CODEC 104 is integral to cache device 102. It should be understood that this illustration is for the sake of example only, and the CODEC 104 need not be integral to cache device 102. Indeed the present disclosure envisions embodiments in which CODEC 104 is stored and/or implemented at any suitable location. For example, CODEC 104 may be a hardware codec implemented by other hardware of a host system, such as a video card or other hardware accelerator. Alternatively or additionally, CODEC may be a software codec that is executed by a processor, e.g., of a host system.

Regardless of the nature of CODEC 104, the compressed output produced by CODEC 104 may be stored in buffer 105. Accordingly, buffer 105 may be configured to store the compressed output of codec 105. In particular, buffer 105 may store the compressed output of codec 105 prior to writing the compressed output to memory 106 of cache device 102. As will be described later, writing the compressed output to memory 106 may be conditioned on the receipt of a data write command (e.g., a write command), e.g., from CCM 101. Moreover prior to commission of the compressed output to memory 105 (e.g., while the compressed output is stored in buffer 105), the location to which the compressed output is to be written (e.g., logical block addresses in memory 106) may be determined by CCM 101, as will be described further below. Buffer 105 may therefore be understood to be a transfer buffer that may store the compressed output of codec 104 prior to commission of the compressed output to cache memory 106.

Buffer 105 may be any memory structure that is suitable for storing the compressed output. Non-limiting examples of suitable memory structures that may be used as buffer 105 include static random access memory (SRAM), embedded dynamic random access memory, combinations thereof, and the like. Without limitation, in some embodiments the size of buffer 105 is greater than or equal to about the size of the cache lines received from CCM 101. Thus for example where CCM 101 transmits 4 KB cache lines to cache device 102, the size of buffer 105 may in some embodiments be greater than or equal to about 4 KB. Of course this is for the sake of example only, and buffer 105 may be any desired size.

Memory 106 may be any suitable type of computer readable memory. Exemplary memory types that may be used as memory 106 include but are not limited to: phase change memory (PCM), a three dimensional cross point memory, a resistive memory, nanowire memory, ferro-electric transistor random access memory (FeTRAM), flash memory such as NAND or NOR memory, magnetoresistive random access memory (MRAM) memory that incorporates memristor technology, spin transfer torque (STT)-MRAM, magnetic drive memory, optical drive memory, combinations thereof, and the like. Additionally or alternatively, memory 106 may include other and/or later-developed types of computer-readable memory.

Without limitation, in some embodiments memory 106 is a type of memory that is typically associated with the type of memory device used as cache device 102. Thus for example, when cache device 102 is a solid state drive, memory 106 may be in the form of non-volatile memory. Likewise when cache device 102 is a hard drive, memory 106 may be in the form of a magnetic recording medium. Without limitation, in some embodiments cache device 102 is in the form of an SSD, and memory 106 is in the form of non-volatile memory (e.g., NAND memory). In any case, memory 106 may be configured to store data in one or more logical blocks, which may be addressed, e.g., with a memory controller or other component of cache device 102. That is, memory 106 may include or be arranged in a plurality of logical block addresses (LBAs), at which data/state may be stored. Data may be written to memory 106 in response to a data write command as generally understood in the art. The data write command may be in the form of a write command that specifies the logical block addresses within memory 106 to which data/state associated with the command is to be written.

For the sake of example the present disclosure will now proceed to describe the operation of an embodiment of cache system 100 in which cache device 102 is in the form of an SSD and memory 106 is in the form of non-volatile memory. It is stressed that the following description is for the sake of example, and that the operations described in association with this example may be employed with any suitable cache device.

With further reference to FIG. 1, CCM 101 may receive data from a data source, such as a processor or another component of a host system in which cache system 100 may be installed. As noted above CCM 101 may apply one or more caching polies to determine whether all or a portion of the data is to be written to memory 106. When CCM 101 determines that all or a portion of the data is to be written to memory 106, it may allocate the to-be written data to one or more cache lines, which may be fixed or variable in size. Without limitation, in some embodiments the cache lines have a fixed size, e.g., 4 KB, 6 KB, 8 KB, 16 KB, 32 KB, 64 KB, etc.

CCM 101 may also assign a tag to the data in a cache line. In general, the tag functions as an identifier of a particular unit of data, in this case the data that is allocated to a one of the cache line. The tag may therefore be in any format suitable to uniquely identify the data in a cache line with which the tag is associated. Thus for example, CCM 101 may assign a first tag “A” to data in a first cache line, and a second tag “B” to data in a second cache line, etc. The nature and format of the tag associated with a cache line is not limited, so long as it is able to uniquely identify the data in the cache line. Thus for example, the tag may be in the form of a 32-bit, 64-bit, 128-bit, or 256-bit sequence number, a hash of the data in the cache line, combinations thereof, and the like. Without limitation, in some embodiments the tag is in the form of a 64-bit sequence number.

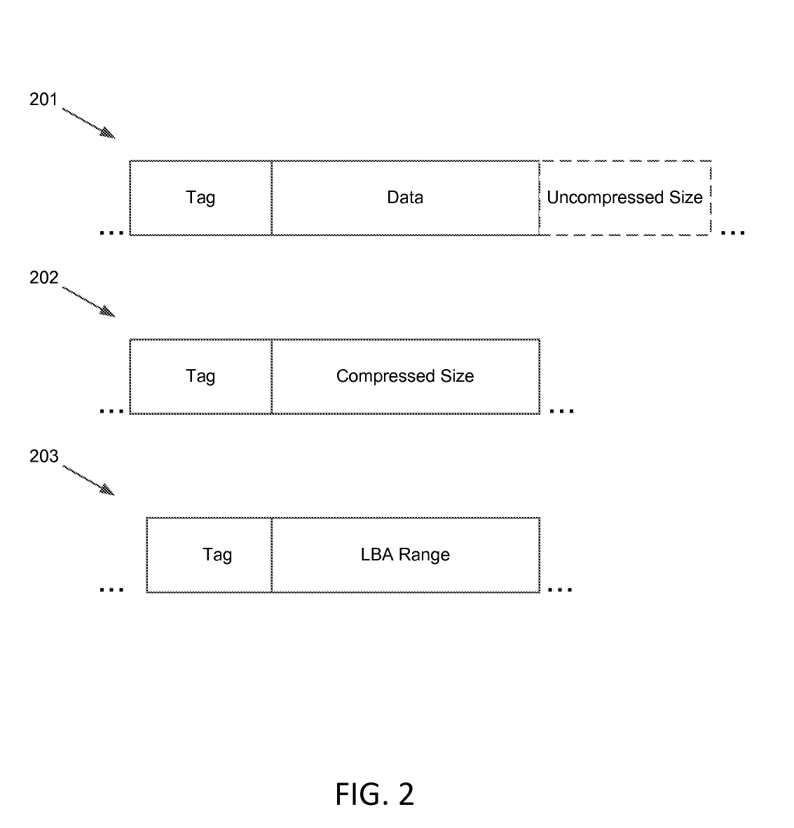

CCM 101 may then send the data in a cache line to cache device 102 for compression, as illustrated by point 1 of FIG. 1. In this regard, CCM 101 may send compress command to cache device 102, e.g., in one or more wired or wireless signals. The compress command may be in any suitable format, such as a vendor specific command under any previous, current or future developed version of the serial advanced technology attachment (SATA) standard or non-volatile memory express (NVMe) standard. In any case the compress command may include a copy of the tag, the input data for compression (i.e., the data in a cache line), and optionally a measurement of the uncompressed size of the input data in the command. This concept is illustrated in FIG. 2, wherein compress command 201 is illustrated in the form of a single command that includes the tag, the input data, and optionally a measurement of the uncompressed size of the input data. Of course the compress command may include other elements as desired, such as but not limited to a command header. The compress command may also include or be associated with one or more compress instructions, which may be configured to cause CODEC 104 to perform compression operations on the input data. Of course, the tag, data, and compress instruction need not be included in the same command, and may be included in different commands as desired.

DCM 103 may receive the compress command directly from CCM 101, or the compress command may be forwarded to DCM 103 from other components of cache device 102. In any case, in response to the compress command DCM 103 may forward the input data received from cache controller module to CODEC 104 for compression. In response, CODEC 104 may execute one or more compression operations on the input data, e.g., using one or more compression algorithms as previously described. As illustrated at point 2 of FIG. 1, CODEC 104 may store the resulting compressed output in transfer buffer 105. CODEC 104 may then report the completion of the compression operation and the location of the compressed output (e.g., an identifier of buffer 105, address ranges within buffer 105, etc.) to DCM 103.

As illustrated at point 3 of FIG. 1, DCM 103 may communicate a return message to CCM 101. The return signal may include the tag assigned to the input data, as well as a measurement of the size of the compressed output stored in DCM 103. This concept is shown in FIG. 2, wherein return message 202 is illustrated as including the tag and the size of the compressed output. Therefore in some embodiments, DCM 103 may measure or otherwise determine the size of the compressed output stored in buffer 105, and include the determined size in a return command. Alternatively or additionally, CODEC 104 may be configured to automatically communicate the size of the compressed data to DCM 103, e.g., after it compresses the input data.

While the present disclosure envisions embodiments in which DCM 101 automatically issues a return message specifying the compressed size and tag to CCM 101, the systems of the present disclosure need not be configured in that manner. Indeed in some embodiments, DCM 103 may condition the issuance of a return message on receipt of a query message from CCM 101. For example as input data from CCM 101 is compressed by CODEC 104 and stored in transfer buffer 105, DCM 103 may maintain a record (e.g., a table or other data structure) correlating tags associated with input data (e.g., various different cache lines) received from CCM 101 with the size of the compressed output associated with the tags, as well as the location of the compressed output (e.g. in buffer 105). DCM 101 may then await receipt of a query command from CCM 101. For example, CCM 101 in some embodiments may transmit a query command to DCM 103, wherein the query command includes a query instruction and a tag. In response to the query command, DCM 103 may look up the size of the compressed output associated with the tag, and send a return message including the tag and the size of the compressed output to CCM 101 as discussed above.

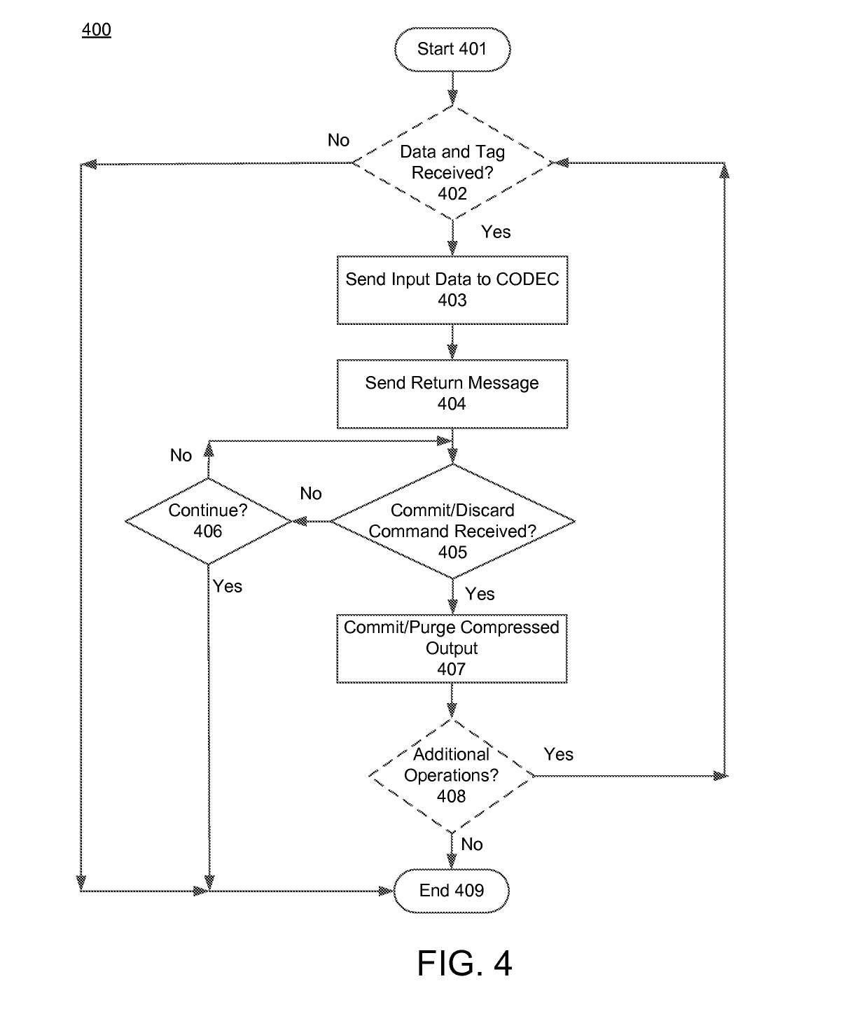

In any case as illustrated at point 4 of FIG. 4, CCM 101 may receive a return message from cache device 102 (or more particularly, from DCM 103). In response to receipt of the return message, CCM 101 may analyze the return message to identify the tag and the size of the compressed data. Through this analysis, CCM 101 can determine the degree to which the input data associated with the tag was compressed by CODEC 104. Put in other terms, by analyzing the return message, CCM 101 can determine the size of the compressed output stored in buffer 105. Because the compressed output in associated with the tag (in the return message) and the tag was associated with the input data (in the compress command), CCM 101 can therefore determine the size of the compressed output, and/or the degree to which the input data was compressed by CODEC 104 (i.e., the input data's compression ratio).

CCM 101 may then determine where the compressed output is to be stored in memory 106. In this regard CCM 101 may have knowledge of the logical block addresses (LBAs) within memory 106, as well as the current state of those logical block addresses (e.g., as being written, unwritten, etc.). For example CCM 101 may maintain an LBA table that identifies all of the LBAs in memory 106. Based at least in part on the size of the compressed output and/or the compression ratio attributable to the input data, CCM 101 may then allocate one or more LBAs within memory 106 for storage of the compressed output.

As shown at point 5 of FIG. 1, CCM 101 may then issue a write command to cache device 102. In general, the write command may be configured to cause cache device 102 to write a compressed output stored in buffer 105 to one or more LBAs of memory 106. Accordingly, the write command may include a tag associated with a compressed output (and corresponding input data) as well as one or more LBAs to which the compressed output is to be written. This concept is illustrated in FIG. 2, wherein write command 203 is illustrated as a single command including a tag and one or more LBAs in memory 106 to which the compressed output associated with the tag is to be written. A write/commit instruction (not shown) may also be included in the command or separately transmitted by CCM 101, as desired.

Turning now to point 6 of FIG. 1, DCM 103 may be configured to receive the write command from CCM 101. In response to the write command, DCM 103 may cause cache device 102 to write the compressed data associated with the tag identified in the write command from buffer 105 to the one or more logical block addresses of memory 106 specified in the write command. Writing the compressed data from buffer 105 to memory 106 may occur in any previously known or to be developed manner, and therefore is not discussed herein.

For the sake of clarity the above discussion focused on an embodiment in which CCM 101 determines that a compressed output stored in buffer 105 is to be written to memory 106 of cache device 102. It should be understood that the above discussion is for the sake of example only, and that a compressed output stored in buffer 105 need not always be written to memory 106 of cache device 102. Indeed the present disclosure envisions embodiments in which CCM 101, in response to a return message, determines that a compressed output stored in buffer 105 is not to be written to memory 106.

By way of example, in some embodiments CCM 101 may analyze a return message to determine the size of a compressed output stored in buffer 105, and/or a compression ratio attributable to input data, as discussed above. In such embodiments CCM 101 may also be configured to determine, based at least in part on the compression ratio and/or the size of the compressed output, whether to write the compressed output to memory 106. For example CCM 101 may compare the compression ratio attributable to input data to a threshold compression ratio, and determine whether or not the compressed output is not to be written to memory 106 based at least in part on whether the compression ratio attributable to the input data exceeds the threshold compression ratio, or not. Alternatively or additionally, CCM 101 may compare the size of the compressed output in buffer 105 to a threshold size, and determine whether or not the compressed output is to be written to memory 106 based at least in part on whether the size of the compressed output exceed the threshold size, or not.

In instances where CCM 101 determines that the compressed output is not to be written to memory 106, CCM 101 may issue a discard command to cache device 102 (or, more particularly, to DCM 103). The discard command may include, for example, a discard instruction and a tag. In response to the discard command, DCM 103 may cause the cache device 102 to purge the compressed output associated with the tag from buffer 105.

As discussed above the present disclosure envisions embodiments in which CCM 101 associates a tag with cache line data that is to be compressed, DCM 103 associates the tag with the compressed data stored in transfer buffer 105, and CCM issues a write command containing the tag to write the compressed data to memory 106. Although useful it should be understood that such embodiments are for the sake of example, and that the present disclosure envisions embodiments in which a tag is not used to identify data in a cache line. For example, CCM 101 may be configured to transmit a compress command to cache device 102, as noted above. Unlike the foregoing embodiments however, the compress command may contain data/state from a cache line for compression, but may not contain a tag. In response to the compression command, DCM 103 may forward the data/state to CODEC 104 for compression, after which the compressed output may be stored in the transfer buffer 105. DCM 103 may then send a return signal to CCM 101, signaling completion of the compression operation and the location/identification of transfer buffer 105 in which the compressed output is stored.

When CCM determines that the compressed output is to be written to memory 106, it may issue a read command to cache device 102. The read command may target the transfer buffer 105, and cause cache device 102 to provide the content of transfer buffer 105 to cache controller 101. CCM 101 can then determine the size and/or compression ratio of the data read from transfer buffer 105, and allocate logical block addresses within memory 106 for the storage thereof. CCM 101 can then issue a write command to cache device 102, including the compressed output and the allocated LBAs of memory 106. In response to the write command, cache device 102 may write the compressed output to the allocated LBA's specified in the write command.

As may be appreciated, such embodiments may allow CCM 101 to determine the size and/or compression ratio of the compressed output prior to writing the compressed output to memory 106 while avoiding the overhead associated with generating and tracking a tag for each cache line, though potentially at the expense of having to wait for compression to complete on state for a given cache line before additional data may be sent.

As noted previously the cache systems of the present disclosure be included in one or more cache devices and/or electronic devices, e.g., and may cache one or more storage devices. This concept is illustrated in FIG. 5A, which depicts a block diagram of an electronic device including a cache system consistent with the present disclosure. As shown, electronic device 500 includes device platform 501, processor 502, storage device 503, a cache device (in this case SSD 504), input/output interface/device (e.g., a keyboard, mouse, etc.), and display 506. SSD 504 includes a cache system 100, further details of which are shown in FIG. 5B.

Electronic device 500 may be any suitable electronic device, such as the electronic devices described above. Non-limiting examples of electronic devices that may be used as electronic device 500 therefore include any kind of mobile device and/or stationary device, such as cameras, cell phones, computer terminals, desktop computers, electronic readers, facsimile machines, kiosks, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. Such devices may be portable or stationary. In some embodiments the technologies described herein may be employed in a desktop computer, laptop computer, smart phone, tablet computer, netbook computer, notebook computer, personal digital assistant, server, combinations thereof, and the like.

Device platform may be any suitable device platform, and in some embodiments correlates to the type of electronic device used as electronic device 500. Thus for example where electronic device 500 is a smart phone, notebook computer, desktop computer, server, etc., device platform 501 may be in the form of a smart phone platform, a notebook computer platform, a desktop computer platform, a server platform, respectfully. Of course such device platforms are for the sake of example only, and any suitable device platform may be used as device platform 501.

Processor 502 may be any suitable general purpose processor or application specific integrated circuit, and may be capable of executing one or multiple threads on one or multiple processor cores. Without limitation, in some embodiments processor 502 is a general purpose processor, such as but not limited to the general purpose processors commercially available from INTEL® Corp., ADVANCED MICRO DEVICES®, ARM®, NVIDIA®, APPLE®, and SAMSUNG®. While FIG. 5A illustrates electronic device 500 as including a single processor 502, multiple processors may be used.

Storage device 503 may be any suitable storage device, such as but not limited to the storage devices noted above. Without limitation, in some embodiments storage device 503 is in the form of an SSD, a hard disk drive, tape memory, combinations thereof, and the like. In some embodiments storage device 503 may exhibit input output performance that is slower than the input output performance of the cache device used in in electronic device 500, in this case SSD 504.

Reference is now made to FIG. 5B, which provides further details of SSD 504 in FIG. 5A and other components of electronic device 500. As shown in FIG. 5B, SSD 504 may communicate with bus 506 (of device platform 501), e.g., via interface 505. In this regard, any suitable bus may be used as bus 506, and any suitable interface may be used as interface 505. Without limitation, bus 506 in one embodiment is a serial advanced technology attachment (SATA) bus, and interface 505 is a SATA interface. As further shown in FIG. 5B, SSD 504 may include cache controller module (CCM) 101, data compression module (DCM) 103, CODEC 104, buffer 105, and memory 106. For the sake of illustration CCM 101, DCM 103, and CODEC 104 are shown as separate elements of SSD 504, but it should be understood that such a configuration is not necessary. Indeed in some embodiments, one or a combination of such elements may be integrated or otherwise included in a SSD controller (not shown) of SSD 504.

In operation, bus 506 may carry data (e.g., from processor 502) to SSD 504. SSD 504 may receive the data, e.g., via interface 505. The received data may then be conveyed to CCM 101. At that time CCM 101 may apply one or more cache policies to determine whether all or a portion of the data is to be written to memory 106. If so, CCM 101 may divide the data into one or a plurality of cache lines as previously discussed, and send one or more of the cache lines (optionally marked with a tag) to DCM 103 for compression. As discussed above, DCM 103 may send data (input data) to CODEC 104 for compression. CODEC 104 may compress the input data to produce an output, which is stored in buffer 105.

CCM 101 may then determine the size of the compressed output and/or a compression ratio attributable to the input data, and may apply one or more caching policies to determine whether the compressed output is to be written to memory 106. As discussed previously that decision may be predicated at least in part on the size of the compressed output and/or the compression ratio attributable to the input data. When the compressed output is to be written to memory 106, CCM 101 may allocate at least one logical block address range in memory 106 for the storage of the compressed output. CCM 101 may then send a write command to a disk controller (not shown) of SSD 504, wherein the write command causes the controller to write the compressed output stored in buffer 105 to the logical block address range(s) of memory 106 allocated by CCM 101. Alternatively where CCM 101 is integral with or in the form of a disk controller of SSD 504, CCM 101 may itself cause the compressed output in buffer 105 to be written to the allocated logical block address range(s) of memory 106. Likewise in instances where the compressed output is not to be written to memory 106, CCM 101 may issue a discard command, causing the compressed output to be purged from buffer 105, e.g., before it is written to memory 106.

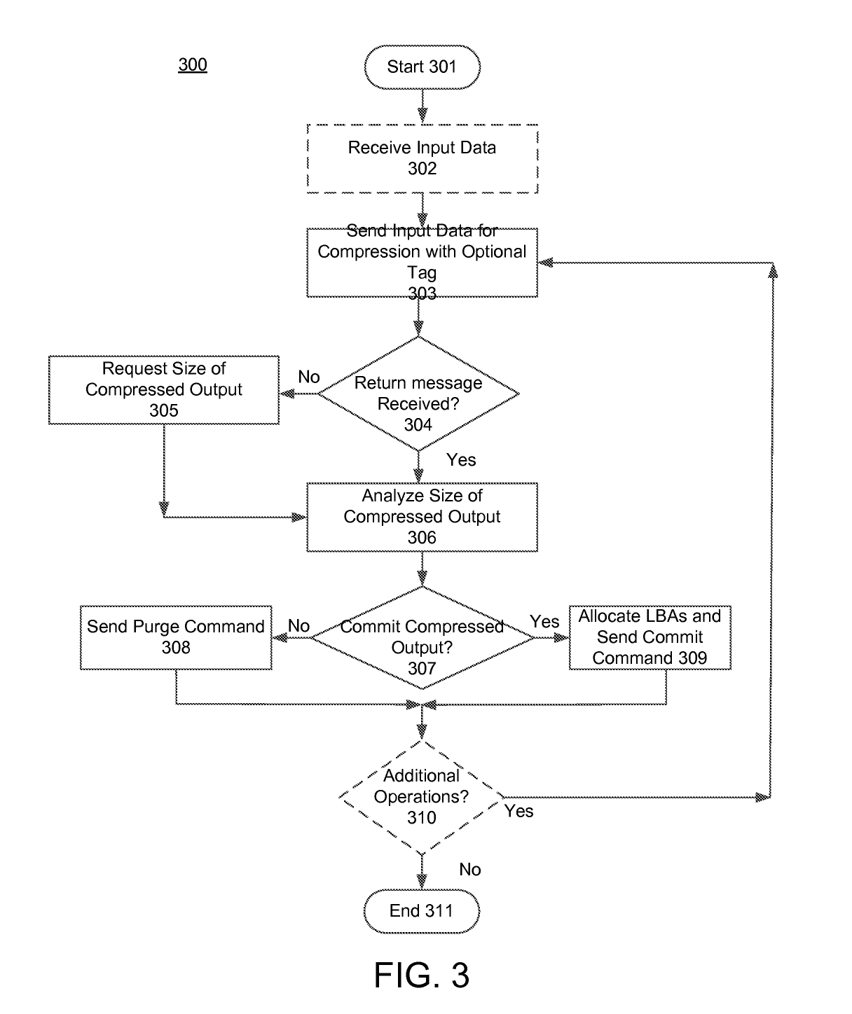

Another aspect of the present disclosure relates to methods of caching data. In this regard reference is made to FIG. 3, which is a flow chart of example operations of a cache controller module in accordance with an example method of caching data consistent with the present disclosure. As shown, the method 300 begins at block 301. The method may then proceed to optional block 302, at which time the cache controller module may receive input data from a source, such as another component of a host system. Block 302 is indicated as optional because performance of the operations described herein may not be conditioned on receipt of the data by a cache controller module. For example, a cache controller module may perform the operations described herein on data that is received by and or stored in another component of a caching or host system, as desired.

In any case the method may proceed to block 303, wherein the cache controller module may send input data for compression and an optional tag, e.g., to a data compression module as described above. Consistent with the foregoing description, in some embodiments the cache controller module may divide the input data into fixe size cache lines, and associate the data in each cache line with a tag. The cache compression module may then transmit the data in a cache line and its associated tag to a data compression module of a cache device, e.g., in a compression command. Consistent with the foregoing, the compression command may be configured to cause the data compression module to forward the input data to a codec for compression. Alternatively in embodiments wherein a tag is not used, the compress command may include the data in a cache line and may be configured to cause a data compression module to forward the input data to a codec for compression and to report the location (transfer buffer) of the compressed output to the cache controller module.

The method may then proceed to block 304, wherein the cache controller module may make a determination as to whether return message has been received, e.g., from a data compression module. As noted above the return message may include a copy of the tag that the cache controller module assigned to input data in block 303, and which a data compression module has also correlated with a compressed output that was produced by compressing the input data. The return message may also include the size of the compressed output, as previously described. Alternatively in instances where a tag is not used, the return command may include the identity of the transfer buffer in which the compressed output is stored.

If a return message has not been received, the cache controller module may continue to await receipt of a return message, and/or the method may proceed to block 305. Pursuant to block 305, the cache controller module may transmit a query message to a cache device (or, more particularly, to a data compression module thereof). As noted above, the query message may cause the cache device and/or device compression module to report the size of compressed output associated with a tag. Alternatively where a tag is not used, the query message may cause the data compression module to report the location of the compressed output, e.g., the identity of transfer buffer 105.

If a return message has been received or if the cache controller module has obtained the size of the compressed output by other means (e.g. via a query message), the method may proceed to block 306. Pursuant to block 306 the cache controller module may analyze the size of the compressed output associated with a tag and/or a compression ratio attributable to an input data associated with the tag, as generally discussed above. Alternatively where a tag is not used, the cache controller module may issue a read command targeting the transfer buffer in which the compressed output it stored, and may determine the size of the compressed output and/or compression ratio of the corresponding input data from the content of the transfer buffer that is read out in response to the read command.

The method may then proceed to block 307, wherein a determination may be made as to whether the compressed output is to be written to memory of a cache device. As discussed above, in some embodiments this determination may be based at least in part on a comparison of the size of the compressed output and/or a compression ratio attributable to input data to one or more thresholds.

If a determination is made not to write the compressed output to memory of the cache device the method may proceed to block 308, wherein the cache controller module may transmit a purge command. As noted above the purge command may be configured to cause a cache device to purge compressed data associated with a tag from a transfer buffer in the cache device. However if a determination is made to write the compressed output to memory of the cache device, the method may proceed to block 309.

Pursuant to block 309 the cache controller module may allocate one or more logical block addresses of the memory of cache device for storage of the compressed output. As discussed above, the cache controller in some embodiments may allocate the LBAs based at least in part on the size of the compressed output associated with a tag and/or a compression ratio attributable to the input data associated with the tag. In any case the cache controller module may then transmit a write command containing the tag and the allocated LBA(s) to the cache device. Alternatively where a tag is not used, the cache controller module may transmit a write command containing the compressed data (read out from the transfer buffer) and the allocated LBA(s) to the cache device. In either case the write command may be configured to cause the cache device to write the compressed output to the LBA(s) identified in the write command.

Following transmission of a purge command pursuant to block 308 or a write command pursuant to block 309, the method may proceed to optional block 310. Pursuant to this optional block a determination may be made as to whether additional operations are to be performed. In some embodiments the outcome of this determination may be conditioned on whether there is additional input data that may be potentially written to cache memory. If additional operations are to be performed, the method may loop back to block 303 and repeat. If no additional operations are to be performed however, the method may proceed to block 311 and end.

Reference is now made to FIG. 4, which is a flow diagram of example operations of a data compression module consistent with one example method of compressing data consistent with the present disclosure. As shown, method 400 may begin at block 401. The method may then proceed to optional block 402, wherein a data compression module may make a determination as to whether a compress command containing input data and an optional tag has been received. Block 402 is illustrated as optional because further operations of the method may not be conditioned on the determination, but rather the receipt of the input data and the optional tag. As noted above, the compress command may be issued from a cache controller module that has divided data into one or a plurality of cache lines, with data in each cache line optionally being associated with a unique tag.

If is determined that input data and optionally a tag have not been received, the method may proceed to block 409 and end. If an input data and optionally a tag have been received however the method may proceed to block 403. In embodiments in which a tag is not used but input data has been received, the method may proceed to block 403

Pursuant to block 403 the data compression module may transmit the input data to a CODEC for compression, as generally described above. For example the data compression module may transmit a compression instruction and the input data to the CODEC. The compression instruction may be configured to cause the CODEC to perform one or more compression operations on the input data, and to store the resulting compressed output in a transfer buffer of a cache device, as discussed above.

The method may then proceed to block 404, wherein the data compression module may send a return message to the cache controller module. As noted above, transmission of the return message may be performed automatically (e.g., in response to completion of the compression operations by the CODEC), or in response to a query from the cache controller module. In any case the return message may include the tag associated with the input data (and the compressed output), as well as the size of the compressed output. Alternatively where a tag is not used, the return message may specify the location (e.g., identify of the transfer buffer) in which the compressed output is stored.

At this point the method may proceed to block 405, wherein a determination may be made as to whether a commit/discard command has been received. As noted above the write command may be sent by the cache controller module, and may include a write instruction, the tag associated with the compressed output, and one or more logical block addresses of a cache memory to which the compressed output is to be written. In contrast, a discard command may include the tag associated with the compressed output, along with a discard instruction. Alternatively if a tag is not used, the write command may include all or a portion of the compressed output that was previously read out from a transfer buffer, as well as one or more logical block addresses of a cache memory to which the compressed output is to be written. Likewise in embodiments where a tag is not used, the discard command may target the transfer buffer in which the compressed output is stored, instead of using the tag.

If a commit or discard command has not been received the method may proceed to block 406, wherein a determination may be made as to whether the data compression module is to continue to await receipt of such a command. The outcome of this determination may be conditioned, for example, one whether a threshold period of time has expired. If the data compression module is to continue awaiting receipt of a commit or discard command, the method may loop back to block 405. Otherwise the method may proceed to block 409 and end.

When a commit or discharge command has been received, the method may proceed to block 407, wherein the data compression module may cause a cache device to commit or purge the compressed output stored in the transfer buffer, as appropriate. For example when a discard command containing a tag is received, the data compression module may cause the cache device to discard the compressed output that is associated with the tag in the command, and which is stored in the transfer buffer of the cache device. Alternatively where a tag is not used and a discard command is received and specifies the location of a transfer buffer, the data compression module may cause the cache device to discard the compressed output stored in the identified transfer buffer.

Alternatively when a write command including a tag is received, the data compression module may cause the cache device to write the compressed output associated with the tag to the logical block addresses of the cache memory specified in the write command. Data compression module may perform such operations, for example, by issuing a write command configured to cause the cache device to write the compressed data associated with the tag in the write command to the logical block addresses of the cache memory specified in the write command. In instances where a tag is not used, the write command may include the compressed output to be written (e.g., which was previously read from the transfer buffer). In such instances the data compression module may cause the cache device to write the compressed output in the write command to the logical block address(es) specified in the write command.

At this point the method may proceed to operation block 408, wherein a determination may be made as to whether additional operations are to be performed. In some embodiments the outcome of this determination may be conditioned on whether there is additional input data and/or compressed outputs that may be potentially written to cache memory. If additional operations are to be performed, the method may loop back to block 402 and repeat. If no additional operations are to be performed however, the method may proceed to block 409 and end.

As may be appreciated from the foregoing, the technologies of the present disclosure allow the cache controller module to understand the size of the compressed output before logical block addresses of a cache memory are allocated. As a result, the cache controller module may tailor allocation of the logical block addresses of the cache memory to the size of the compressed output. Moreover because the cache controller module understands the size of each piece of compressed data that is written to memory and the size of the cache memory, it may be aware of the allocation and/or availability of logical block addresses in the cache memory without the need to query the cache device for that information. The technologies described herein may therefore allow for more a seamless and/or efficient compressing in caching system. Such advantages may also be attained without affecting read commands targeting the cache memory.

### EXAMPLES

The following examples pertain to further embodiments. The following examples of the present disclosure may comprise subject material such as a system, a device, a method, a computer readable storage medium storing instructions that when executed cause a machine to perform acts based on the method, and/or means for performing acts based on the method, as provided below.

### Example 1

One example of the present disclosure is a system including a cache controller module, wherein the cache controller module is configured to: transmit a compress command including input data to a compression engine, the compress command configured to cause the compression engine to compress the input data to produce a compressed output and to store the compressed output in a transfer buffer; determine at least one of a size of the compressed output and a compression ratio attributable to the input data prior to writing the compressed output to a memory of a cache device; when the compressed output is to be written to the memory of the cache device, allocate at least at least one logical block address (LBA) range in the memory device for the storage of the compressed output based at least in part on the size of the compressed output, the compression ratio, or a combination thereof.

### Example 2

This example includes any or all of the features of example 1, wherein the compression engine is part of the cache device.

### Example 3

This example includes any or all of the features of any one of examples 1 and 2, wherein the transfer buffer is part of the cache device.

### Example 4

This example includes any or all of the features of any one of examples 1 to 3 wherein: the cache controller module is further configured to associate the input data with a tag and to transmit the tag in the compress command; in response to the compress command, the tag is associated with the compressed output in the temporary buffer; and when the compressed output is to be written to the memory of the cache device, the cache controller module issues a write command containing the tag and the at least one LBA range to the cache device, the write command configured to cause the cache device to write the compressed output associated with the tag to the at least one LBA range of the memory specified in the write command.

### Example 5

This example includes any or all of the features of any one of examples 1 to 4, wherein the cache controller module is further configured to receive a return message from the cache device, the return message including the tag and a measurement of the size of the compressed output; and determine, in response to receipt of the return message, at least one of the size of the compressed output and the compression ratio attributable to the input data.

### Example 6

This example includes any or all of the features of any one of examples 1 to 5, wherein when the compressed output is to be written to the memory of the cache device, the cache controller module is further configured to: read the compressed output from the transfer buffer; and transmit a write command containing the compressed output and the at least one LBA range to the cache device, the write command configured to cause the cache device to write the compressed output in the write command to the at least on LBA range of the memory specified in the write command.

### Example 7

This example includes any or all of the features of any one of examples 1 to 6, wherein the cache controller module is further configured to receive a return message from the cache device, the return message including the location of the transfer buffer in which the compressed output is stored; read the compressed output at least in part by issuing a read command targeting the location of the transfer buffer in which the compressed output is stored; and determine at least one of the size of the compressed output and the compression ratio attributable to the input data from the compressed output read from the transfer buffer.

### Example 8

This example includes any or all of the features of any one of examples 1 to 7, wherein the cache controller module is configured to allocate the at least one LBA range prior to writing the compressed output to the memory.

### Example 9

This example includes any or all of the features of any one of examples 1 to 8, wherein a size of the at least one LBA range substantially corresponds to the size of the compressed output.

### Example 10

This example includes any or all of the features of any one of examples 1 to 9, wherein a size of the transfer buffer is greater than or equal to a size of the cache line.

### Example 11

This example includes any or all of the features of any one of examples 1 to 10, wherein the cache line is one or a plurality of cache lines, and each cache line of the plurality of cache lines is the same size.

### Example 12

This example includes any or all of the features of any one of examples 1 to 11, wherein the cache controller module is further configured to implement one or more caching policies to determine whether to store the input data in the memory of the cache device.

### Example 13

This example includes any or all of the features of any one of examples 1 to 12, wherein the cache controller is further configured to implement one or more caching policies to determine whether to store the compressed output in the memory of the cache device.

### Example 14

This example includes any or all of the features of any one of examples 1 to 13, wherein the cache controller is further configured to determine whether to store the compressed output in the memory of the cache device prior to the compressed data being written to the memory of the cache device.

### Example 15

This example includes any or all of the features of any one of examples 1 to 14, wherein the cache controller module is further configured to determine whether to store the compressed output in the memory of the cache device based at least in part on the size of the compressed output.

### Example 16

This example includes any or all of the features of any one of examples 1 to 15, wherein the cache controller module is further configured to determine whether to store the compressed output to the memory of the cache device based at least in part on a comparison of the size of the compressed output to a threshold size.

### Example 17

This example includes any or all of the features of any one of examples 1 to 16, wherein the cache controller module is further configured to issue, prior to receipt of the return message, a query command to the cache device, the query command configured to cause the cache device to communicate the return message to the cache controller module.

### Example 18

This example includes any or all of the features of any one of examples 1 to 17, wherein the cache controller module is further configured to issue a discard command when the compressed output is not to be written to the memory of the cache device, the discard command configured to cause the cache device to purge the compressed output from the transfer buffer.

### Example 19

This example includes any or all of the features of any one of examples 1 to 18, wherein the compressed output is not written to the memory of the cache device before it is purged from the transfer buffer.

### Example 20

According to this example there is provided a system including a data compression module, wherein the data compression module is configured to: in response to receipt of a compress command from a cache controller module, the compress command including input data of a cache line, issue a compress instruction to a compression decompression engine, the compress instruction configured to cause the compression decompression engine to compress the input data to produce a compressed output and to store the compressed output in a transfer buffer of a cache device; communicate a return message to the cache controller module, the return message configured to cause the cache controller module to: determine at least one of a size of the compressed output and a compression ratio attributable to the input data; and when the compressed output is to be written to a memory of the cache device, allocate at least one logical block address range in a memory of the cache device for the storage of the compressed output, based at least in part on the size of the compressed output, the compression ratio, or a combination thereof.

### Example 21

This example includes any or all of the features of example 20, wherein the data compression module is further configured to: in response to receipt of a write command including the at least one logical block address allocated by the cache controller module, issue a write command configured to cause the cache device to write the compressed data to the logical block addresses of the memory specified in the write command.

### Example 22

This example includes any or all of the features of any one of examples 20 and 21, wherein prior to receipt of the write command, the compressed data is not written to the memory of the cache device.

### Example 23

This example includes any or all of the features of any one of examples 20 to 22, wherein: the compress command includes a tag associated with the input data; in further response to the compress command, the data compression module associates the tag with the compressed output; and the return message includes the tag and the size of the compressed output.

### Example 24

This example includes any or all of the features of any one of examples 20 to 23, wherein the data compression module is further configured to condition transmission of the return message on the receipt of a query command from the cache controller module.

### Example 25

This example includes any or all of the features of any one of examples 20 to 24, wherein the cache device includes the compression decompression engine.

### Example 26

This example includes any or all of the features of any one of examples 20 to 25, wherein the return message is configured to cause the cache controller module to allocate the at least one logical block address prior to the compressed data being written to the memory.

### Example 27

This example includes any or all of the features of any one of examples 20 to 26, wherein a size of the at least one logical block address allocated by the cache controller module correlates to the size of the compressed output.

### Example 28

This example includes any or all of the features of any one of examples 20 to 27, wherein a size of the at least one logical block address allocated by the cache controller module is substantially the same as the size of the compressed output.

### Example 29

This example includes any or all of the features of any one of examples 20 to 28, wherein a size of the transfer buffer is greater than or equal to a size of the cache line.

### Example 30

This example includes any or all of the features of any one of examples 20 to 29, wherein the cache line is one of a plurality of cache lines, and each cache line of the plurality of cache lines is the same size.

### Example 31

This example includes any or all of the features of any one of examples 20 to 30, wherein the return message is configured to cause the cache controller module to determine whether to store the compressed output in the memory of the cache device prior to the compressed data being written to the memory of the cache device.

### Example 32

This example includes any or all of the features of any one of examples 20 to 31, wherein the cache controller module is configured to determine whether to store the compressed output in the memory of the cache device based at least in part on the size of the compressed output.

### Example 33

This example includes any or all of the features of any one of examples 20 to 32, wherein the cache controller module is configured to determine whether to store the compressed output to the memory of the cache device based at least in part on a comparison of the size of the compressed output to a threshold size.

### Example 34

This example includes any or all of the features of any one of examples 20 to 33, wherein the data compression module is further configured to: issue, in response to receipt of a discard command from the cache controller module, a discard instruction to the cache device, the discard instruction configured to cause the cache device to purge the compressed output from the transfer buffer.

### Example 35

This example includes any or all of the features of any one of examples 20 to 34, wherein the compressed output is not written to the memory of the cache device before it is purged from the transfer buffer.

### Example 36

According to this example there is provided a method of caching data, including, with a cache controller module: transmitting input data of a cache line to a compression engine for compression; compressing the input data to produce a compressed output; storing the compressed output in a transfer buffer; determining whether to write the compressed output to a memory of a cache device based at least in part on a size of the compressed output, a compression ratio attributable to the input data, or a combination thereof; and when the compressed output is to be written to the memory, allocating at least one logical block address (LBA) range of the memory for storage of the compressed output based at least in part on the size of the compressed output, the compression ratio attributable to the input data, or a combination thereof.

### Example 37

This example includes any or all of the features of example 36, and further includes: when the compressed output is to be to be written to the memory, issuing a write command from the cache controller module, the write command configured to cause the cache device to write the compressed output from the transfer buffer to the memory.

### Example 38

This example includes any or all of the features of any one of examples 36 and 27, and further includes, with the cache controller module: receiving a return message from a data compression module; and determining at least one of the size of the compressed output and the compression ratio from the return message.

### Example 39

This example includes any or all of the features of any one of examples 36 to 38, and further includes issuing a query command from the cache controller module to the data compression module, the query command configured to cause the data compression module to transmit the return message to the cache controller module.

### Example 40

This example includes any or all of the features of any one of examples 36 to 39, and further includes: associating the input data with a tag; associating the compressed output with the tag; and when the compressed output is to be written to the memory, the write command includes the at least one LBA range and the tag, the write command configured to cause the cache device to write the compressed data associated with the tag from the transfer buffer to the memory.

### Example 41

This example includes any or all of the features of any one of examples 36 to 40, and further includes, with the cache controller module: receiving a return message from a data compression module, the return message including the tag; and determining at least one of the size of the compressed output and the compression ratio based at least in part on the tag contained in the return message.

### Example 42

This example includes any or all of the features of any one of examples 36 to 41, wherein allocating the at least one LBA range occurs prior to writing the compressed data to the memory.

### Example 43

This example includes any or all of the features of any one of examples 36 to 42, wherein a size of the at least one LBA range correlates to the size of the compressed output.

### Example 44

This example includes any or all of the features of any one of examples 36 to 43, wherein a size of the at least one LBA range is substantially the same as the size of the compressed output.

### Example 45

This example includes any or all of the features of any one of examples 36 to 44, wherein a size of the transfer buffer is greater than or equal to a size of the cache line.

### Example 46

This example includes any or all of the features of any one of examples 36 to 45, wherein the cache line is one of a plurality of cache lines, and each cache line of the plurality of cache lines is the same size.

### Example 47

This example includes any or all of the features of any one of examples 36 to 46, and further includes determining whether to store the input data in the memory of the cache device based at least in part one or more caching policies.

### Example 48

This example includes any or all of the features of any one of examples 36 to 47, and further includes determining whether to store the compressed output in the memory of the cache device based at least in part one or more caching policies.

### Example 49

This example includes any or all of the features of any one of examples 36 to 48, wherein determining whether to store the compressed output in the memory of the cache device is based at least in part on the size of the compressed output.

### Example 50

This example includes any or all of the features of any one of examples 36 to 49, wherein determining whether to store the compressed output in the memory of the cache device includes comparing the size of the compressed output to a threshold size.

### Example 51

This example includes any or all of the features of any one of examples 36 to 50, and further includes: when the compressed output is not to be written to the memory of the cache device, issuing a discard command to the cache device, the discard command configured to cause the cache device to purge the compressed output from the transfer buffer.

### Example 52

This example includes any or all of the features of any one of examples 36 to 51, wherein the compressed output is not written to the memory of the cache device before it is purged from the transfer buffer.

### Example 53

According to this example there is provided a method of caching data including, with a data compression module: issuing a compress instruction to a compression decompression engine, the compress instruction configured to cause the compression decompression engine to compress input data of a cache line received from a cache controller module to produce a compressed output and to store the compressed output in a transfer buffer of a cache device; transmitting a return message to the cache controller module, the return message configured to cause the cache controller module to: determine at least one of a size of the compressed output and a compression ratio attributable to the input data; and when the compressed output is to be written to a memory of the cache device, allocate at least one logical block address (LBA) range in a memory of the cache device for storage of the compressed output, based at least in part on the size of the compressed output, the compression ratio, or a combination thereof.

### Example 54

This example includes any or all of the features of example 53, and further includes: issuing, in response to receipt of a write command from the cache controller module, a write command with the data compression module, the write command configured to cause the cache device to write the compressed output from the transfer buffer to the memory.

### Example 55

This example includes any or all of the features of any one of examples 53 and 54, wherein prior to receipt of the write command, the compressed data is not written to the memory of the cache device.

### Example 56

This example includes any or all of the features of any one of examples 53 to 55, wherein: the input data is associated with a tag; in further response to the compress command, the data compression module associates the tag with the compressed output; and the return message includes the tag.

### Example 57

This example includes any or all of the features of any one of examples 53 to 56, wherein the return message further includes the size of the compressed output.

### Example 58

This example includes any or all of the features of any one of examples 53 to 57, wherein transmission of the return message is conditioned on receipt of a query command from the cache controller module.

### Example 59

This example includes any or all of the features of any one of examples 53 to 58, wherein the return message is configured to cause the cache controller module to allocate the at least one logical block address prior to the compressed data being written to the memory.

### Example 60

This example includes any or all of the features of any one of examples 53 to 59, wherein a size of the at least one logical block address allocated by the cache controller module correlates to the size of the compressed output.

### Example 61

This example includes any or all of the features of any one of examples 53 to 60, wherein a size of the at least one logical block address allocated by the cache controller module is substantially the same as the size of the compressed output.

### Example 62

This example includes any or all of the features of any one of examples 53 to 62, wherein the return message is configured to cause the cache controller module to determine whether to store the compressed output in the memory of the cache device prior to the compressed data being written to the memory of the cache device.

### Example 63

This example includes any or all of the features of any one of examples 53 to 62, and further includes, with the data compression module: issuing, in response to receipt of a discard command from the cache controller module, a discard command to the cache device, the discard command configured to cause the cache device to purge the compressed output from the transfer buffer.

### Example 64

This example includes any or all of the features of any one of examples 53 to 63, wherein the compressed output is not written to the memory of the cache device before it is purged from the transfer buffer.

### Example 65

According to this example there is provided at least one computer readable medium including instructions which when executed by a processor of a cache system cause the performance of the following operations including, with a cache controller module: transmitting input data of a cache line to a compression engine for compression; compressing the input data to produce a compressed output; storing the compressed output in a transfer buffer; determining whether to write the compressed output to a memory of a cache device based at least in part on a size of the compressed output, a compression ratio attributable to the input data, or a combination thereof; and when the compressed output is to be written to the memory, allocating at least one logical block address (LBA) range of the memory for storage of the compressed output based at least in part on the size of the compressed output, the compression ratio attributable to the input data, or a combination thereof.

### Example 66

This example includes any or all of the features of example 65, wherein the instructions when executed further cause the performance of the following operations including: when the compressed output is to be to be written to the memory, issuing a write command from the cache controller module, the write command configured to cause the cache device to write the compressed output from the transfer buffer to the memory.

### Example 67

This example includes any or all of the features of any one of examples 65 and 66, wherein the instructions when executed further cause the performance of the following operations including, with the cache controller module: receiving a return message from a data compression module; and determining at least one of the size of the compressed output and the compression ratio from the return message.

### Example 68

This example includes any or all of the features of any one of examples 65 to 67, wherein the instructions when executed further cause the performance of the following operations including: issuing a query command from the cache controller module to the data compression module, the query command configured to cause the data compression module to transmit the return message to the cache controller module.

### Example 69

This example includes any or all of the features of any one of examples 65 to 68, wherein the instructions when executed further cause the performance of the following operations including: associating the input data with a tag; associating the compressed output with the tag; and when the compressed output is to be written to the memory, the write command includes the at least one LBA range and the tag, the write command configured to cause the cache device to write the compressed data associated with the tag from the transfer buffer to the memory.

### Example 70

This example includes any or all of the features of any one of examples 65 to 69, wherein the instructions when executed further cause the performance of the following operations including: receiving a return message from a data compression module, the return message including the tag; and determining at least one of the size of the compressed output and the compression ratio based at least in part on the tag contained in the return message.

### Example 71

This example includes any or all of the features of any one of examples 65 to 70, wherein allocating the at least one LBA range occurs prior to writing the compressed data to the memory.

### Example 72

This example includes any or all of the features of any one of examples 65 to 71, wherein a size of the at least one LBA range correlates to the size of the compressed output.

### Example 73

This example includes any or all of the features of any one of examples 65 to 72, wherein a size of the at least one LBA range is substantially the same as the size of the compressed output.

### Example 74

This example includes any or all of the features of any one of examples 65 to 73, wherein a size of the transfer buffer is greater than or equal to a size of the cache line.

### Example 75

This example includes any or all of the features of any one of examples 65 to 74, wherein the cache line is one of a plurality of cache lines, and each cache line of the plurality of cache lines is the same size.

### Example 76

This example includes any or all of the features of any one of examples 65 to 75, wherein the instructions when executed further cause the performance of the following operations including: determining, with the cache controller module, whether to store the input data in the memory of the cache device based at least in part one or more caching policies.

### Example 77

This example includes any or all of the features of any one of examples 65 to 76, wherein the instructions when executed further cause the performance of the following operations including: determining, with the cache controller module, whether to store the compressed output in the memory of the cache device based at least in part one or more caching policies.

### Example 78

This example includes any or all of the features of any one of examples 65 to 77, wherein determining whether to store the compressed output in the memory of the cache device is based at least in part on the size of the compressed output.

### Example 79

This example includes any or all of the features of any one of examples 65 to 78, wherein determining whether to store the compressed output in the memory of the cache device includes comparing the size of the compressed output to a threshold size.

### Example 80

This example includes any or all of the features of any one of examples 65 to 79, wherein the instructions when executed further cause the performance of the following operations including: when the compressed output is not to be written to the memory of the cache device, issuing a discard command from the cache controller module to the cache device, the discard command configured to cause the cache device to purge the compressed output from the transfer buffer.

### Example 81

This example includes any or all of the features of any one of examples 65 to 80, wherein the compressed output is not written to the memory of the cache device before it is purged from the transfer buffer.

### Example 82

According to this example there is provided at least one computer readable medium including instructions which when executed by a processor of a cache system cause the performance of the following operations including, with a data compressing module: issuing a compress instruction to a compression decompression engine, the compress instruction configured to cause the compression decompression engine to compress input data of a cache line received from a cache controller module to produce a compressed output and to store the compressed output in a transfer buffer of a cache device; transmitting a return message to the cache controller module, the return message configured to cause the cache controller module to: determine at least one of a size of the compressed output and a compression ratio attributable to the input data; and when the compressed output is to be written to a memory of the cache device, allocate at least one logical block address (LBA) range in a memory of the cache device for storage of the compressed output, based at least in part on the size of the compressed output, the compression ratio, or a combination thereof.

### Example 83

This example includes any or all of the features of example 82, wherein the instructions when executed further cause the performance of the following operations including: issuing, in response to receipt of a write command from the cache controller module, a write command with the data compression module, the write command configured to cause the cache device to write the compressed output from the transfer buffer to the memory.

### Example 84

This example includes any or all of the features of any one of examples 82 and 83, wherein prior to receipt of the write command, the compressed data is not written to the memory of the cache device.

### Example 85

This example includes any or all of the features of any one of examples 82 to 84, wherein: the instructions when executed further cause the data compression module to associate the compressed output with a tag, the tag associated with the input data; and the return message includes the tag.

### Example 86

This example includes any or all of the features of any one of examples 82 to 85, wherein the return message further includes the size of the compressed output.

### Example 87

This example includes any or all of the features of any one of examples 82 to 86, wherein transmission of the return message is conditioned on receipt of a query command from the cache controller module.

### Example 88

This example includes any or all of the features of any one of examples 82 to 87, wherein the return message is configured to cause the cache controller module to allocate the at least one logical block address prior to the compressed data being written to the memory.

### Example 89

This example includes any or all of the features of any one of examples 82 to 88, wherein a size of the at least one logical block address allocated by the cache controller module correlates to the size of the compressed output.

### Example 90

This example includes any or all of the features of any one of examples 82 to 89, wherein a size of the at least one logical block address allocated by the cache controller module is substantially the same as the size of the compressed output.

### Example 91

This example includes any or all of the features of any one of examples 82 to 90, wherein the return message is configured to cause the cache controller module to determine whether to store the compressed output in the memory of the cache device prior to the compressed data being written to the memory of the cache device.

### Example 92

This example includes any or all of the features of any one of examples 82 to 91, wherein the instructions when executed further cause the performance of the following operations including, with the data compression module: issuing, in response to receipt of a discard command from the cache controller module, a discard command to the cache device, the discard command configured to cause the cache device to purge the compressed output from the transfer buffer.

### Example 93

This example includes any or all of the features of any one of examples 82 to 92, wherein the compressed output is not written to the memory of the cache device before it is purged from the transfer buffer.

### Example 94

According to this example there is provided at least one computer readable medium including logic implemented at least in part in hardware to perform the method of any one of examples 36 to 52.

### Example 95

According to this example there is provided at least one computer readable medium including logic implemented at least in part in hardware to perform the method of any one of examples 53 to 64.

### Example 96

This example includes any or all of the features of any one of examples 1 to 19, wherein the cache controller module, the compression decompression engine, and the transfer buffer are part of the cache device, and the cache device is a solid state drive.

### Example 97

This example includes any or all of the features of any one of examples 1 to 19 and 96, wherein: the system further includes a processor, a bus, and a storage device; the processor is configured to transmit the input data to the solid state drive via the bus; and the solid state drive is configured as cache for the storage device.

### Example 98

This example includes any or all of the features of any one of examples 20 to 35, wherein the cache controller module, the data compression module, the compression decompression engine, and the transfer buffer are part of the cache device, and the cache device is a solid state drive.

### Example 99

This example includes any or all of the features of any one of examples 20 to 35 and 98, wherein: the system further includes a processor, a bus, and a storage device; the processor is configured to transmit the input data to the solid state drive via the bus; and the solid state drive is configured as cache for the storage device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed is:

1. A system comprising:
a cache controller module, wherein the cache controller module is configured to:
transmit a compress command comprising input data to a compression engine, the compress command configured to cause the compression engine to compress the input data to produce a compressed output and to store the compressed output in a transfer buffer;
determine at least one of a size of the compressed output and a compression ratio attributable to the input data prior to writing the compressed output to a memory of a cache device;
when said compressed output is to be written to the memory of the cache device, allocate at least at least one logical block address (LBA) range in said memory device for the storage of said compressed output based at least in part on the size of the compressed output, the compression ratio, or a combination thereof.

2. The system of claim 1, wherein the compression engine and the transfer buffer are part of the cache device.

3. The system of claim 2, wherein:
the cache controller module is further configured to associate the input data with a tag and to transmit the tag in the compress command;
in response to the compress command, the tag is associated with the compressed output in the temporary buffer; and
when the compressed output is to be written to the memory of the cache device, the cache controller module issues a write command containing the tag and the at least one LBA range to the cache device, the write command configured to cause the cache device to write the compressed output associated with the tag to the at least one LBA range of the memory specified in the write command.

4. The system of claim 3, wherein the cache controller module is further configured to:
receive a return message from the cache device, the return message comprising the tag and a measurement of the size of the compressed output; and
determine, in response to receipt of the return message, at least one of the size of the compressed output and the compression ratio attributable to the input data.

5. The system of claim 2, wherein when the said compressed output is to be written to the memory of the cache device, the cache controller module is further configured to:
read the compressed output from the transfer buffer; and
transmit a write command containing the compressed output and the at least one LBA range to the cache device, the write command configured to cause the cache device to write the compressed output in the write command to the at least on LBA range of the memory specified in the write command.

6. The system of claim 5, wherein the cache controller module is further configured to:
receive a return message from the cache device, the return message comprising the location of the transfer buffer in which the compressed output is stored;
read the compressed output at least in part by issuing a read command targeting the location of the transfer buffer in which the compressed output is stored; and
determine at least one of the size of the compressed output and the compression ratio attributable to the input data from the compressed output read from the transfer buffer.

7. The system of claim 1, wherein the cache controller module is configured to allocate the at least one LBA range prior to writing the compressed output to the memory.

8. The system of claim 1, wherein the cache controller module is further configured to issue a discard command when said compressed output is not to be written to the memory of the cache device, the discard command configured to cause the cache device to purge the compressed output from the transfer buffer.

9. The system of claim 1, wherein the cache controller module, the compression decompression engine, and the transfer buffer are part of the cache device, and the cache device is a solid state drive.

10. The system of claim 10, further comprising a processor, a bus, and a storage device, wherein:
the processor is configured to transmit the input data to the solid state drive via the bus; and
the solid state drive is configured as cache for the storage device.

11. A method of caching data, comprising, with a cache controller module:
transmitting input data of a cache line to a compression engine for compression;
compressing the input data to produce a compressed output;
storing the compressed output in a transfer buffer;
determining whether to write the compressed output to a memory of a cache device based at least in part on a size of the compressed output, a compression ratio attributable to the input data, or a combination thereof; and
when said compressed output is to be written to the memory, allocating at least one logical block address (LBA) range of the memory for storage of the compressed output based at least in part on the size of the compressed output, the compression ratio attributable to the input data, or a combination thereof.

12. The method of claim 11, further comprising:
when said compressed output is to be to be written to the memory, issuing a write command from the cache controller module, the write command configured to cause the cache device to write the compressed output from the transfer buffer to the memory.

13. The method of claim 11, further comprising, with the cache controller module:
receiving a return message from a data compression module; and
determining at least one of the size of the compressed output and the compression ratio from the return message.

14. The method of claim 12, further comprising:
associating said input data with a tag;
associating said compressed output with said tag; and
when said compressed output is to be written to said memory, said write command comprises said at least one LBA range and said tag, said write command configured to cause said cache device to write the compressed data associated with the tag from the transfer buffer to the memory.

15. The method of claim 14, further comprising, with the cache controller module:
receiving a return message from a data compression module, the return message comprising the tag; and
determining at least one of the size of the compressed output and the compression ratio based at least in part on the tag contained in the return message.

16. The method of claim 11, wherein allocating said at least one LBA range occurs prior to writing said compressed data to said memory.

17. The method of claim 11, further comprising determining whether to store the compressed output in the memory of the cache device based at least in part one or more caching policies.

18. The method of claim 11, further comprising:
when said compressed output is not to be written to the memory of the cache device, issuing a discard command to the cache device, the discard command configured to cause the cache device to purge the compressed output from the transfer buffer.

19. At least one computer readable medium comprising instructions which when executed by a processor of a cache system cause the performance of the following operations comprising, with a cache controller module:
transmitting input data of a cache line to a compression engine for compression;
compressing the input data to produce a compressed output;
storing the compressed output in a transfer buffer;
determining whether to write the compressed output to a memory of a cache device based at least in part on a size of the compressed output, a compression ratio attributable to the input data, or a combination thereof; and
when said compressed output is to be written to the memory, allocating at least one logical block address (LBA) range of the memory for storage of the compressed output based at least in part on the size of the compressed output, the compression ratio attributable to the input data, or a combination thereof.

20. The at least one computer readable medium of claim 19, wherein said instructions when executed further cause the performance of the following operations comprising:
when said compressed output is to be to be written to the memory, issuing a write command from the cache controller module, the write command configured to cause the cache device to write the compressed output from the transfer buffer to the memory.

21. The at least one computer readable medium of claim 19, wherein said instructions when executed further cause the performance of the following operations comprising, with the cache controller module:
receiving a return message from a data compression module; and
determining at least one of the size of the compressed output and the compression ratio from the return message.

22. The at least one computer readable medium of claim 20, wherein said instructions when executed further cause the performance of the following operations comprising:
associating said input data with a tag;
associating said compressed output with said tag; and
when said compressed output is to be written to said memory, said write command comprises said at least one LBA range and said tag, said write command configured to cause said cache device to write the compressed data associated with the tag from the transfer buffer to the memory.

23. The at least one computer readable medium of claim 22, wherein said instructions when executed further cause the performance of the following operations comprising:
receiving a return message from a data compression module, the return message comprising the tag; and
determining at least one of the size of the compressed output and the compression ratio based at least in part on the tag contained in the return message.

24. The at least one computer readable medium of claim 19, wherein allocating said at least one LBA range occurs prior to writing said compressed data to said memory.

25. The at least one computer readable medium of claim 19, further comprising determining whether to store the compressed output in the memory of the cache device based at least in part one or more caching policies.
